(19) United States
(12) Patent Application Publication
(10) Pub. No.: US 2014/0087145 A1
(43) Pub. Date: Mar. 27, 2014

(54) SELF-CORRUGATING LAMINATES AND METHODS OF MAKING THEM

(71) Applicant: Eastman Chemical Company, Kingsport, TN (US)

(72) Inventors: Marcus David Shelby, Fall Branch, TN (US); Freddie Wayne Williams, Kingsport, TN (US); Peter Borden MacKenzie, Kingsport, TN (US); Jeffrey Todd Owens, Kingsport, TN (US); Candace Michele Tanner, Kingsport, TN (US); Jennifer Lynne Stikeleather Peavey, Raleigh, NC (US); Scott Allen Clear, Escondido, CA (US)

(73) Assignee: Eastman Chemical Company, Kingsport, TN (US)

(21) Appl. No.: 13/965,288

(22) Filed: Aug. 13, 2013

Related U.S. Application Data
(60) Provisional application No. 61/706,412, filed on Sep. 27, 2012.

(51) Int. Cl. B32B 3/28

(52) U.S. Cl. CPC B32B 3/28
USPC 428/182

(57) ABSTRACT

A self-corrugating laminate is disclosed. The self-corrugating laminate includes an upper and a lower shrinkable film layer each having at least one axis of shrinkage and a non-shrinkable core bonded between the upper and lower shrinkable film layers along bond lines. The bond lines that bond the upper shrinkable film layer to the non-shrinkable core are staggered relative to the bond lines that bond the lower shrinkable film layer to the non-shrinkable core such that upon shrinkage of the shrinkable film layers, structural corrugations are formed in the non-shrinkable core. The shrinkable film layers of the invention exhibit a percent shrinkage along an axis of shrinkage from about 10 to about 45 percent.

### RELATED APPLICATIONS

This application claims priority from U.S. Provisional Application No. 61/706,412, filed on Sep. 27, 2012, the entire disclosure of which is incorporated herein by reference.

### FIELD OF THE INVENTION

The present invention relates to laminate films, and specifically, to laminate films that are useful to form structural corrugates.

### BACKGROUND OF THE INVENTION

The ability to make structural or functional plastic panels is limited to just a few processes because of the low modulus of plastics in general, coupled with the difficulty of generating three-dimensionally-reinforced structures. The processes that are available are either labor-intensive (e.g. thermoforming and bonding) or require extensive tooling (e.g. twin wall sheet extrusion). Parts made by these methods are also typically limited to two-dimensions such as with panels and, once produced, tend to be bulky and cannot be easily shipped or packaged. It is also difficult to introduce functionality into these structures because the core material is not easily modified, being specific to the intended use. It would be an advance in the art to provide rigid, and optionally functional, structural panels that are easily produced and shipped, that may be formed as films and shipped as rolls, and that may then be expanded just prior to use to form structural corrugates. Although prior art corrugates are known in which shrinkable layers assist in forming corrugations, we have found conventional shrinkable materials unsuitable to more demanding applications in which regular, structural corrugations are required.

For example, U.S. Pat. No. 2,607,104 discloses two-ply and three-ply woven corrugated fabrics that are said to be highly resilient in resisting lateral compression. The three-ply fabrics include a top and bottom fabric that can be shrunk or contracted in one direction to a pronounced degree of about 50% when heated, so that the shrinking of the outer fabrics will corrugate the intermediate fabric.

U.S. Pat. No. 3,620,896 discloses a tape having at least two laminae of different coefficients of contraction joined to prevent interlamina relative movement during contraction. The contractable lamina, which may contract as much as 50 to 70 percent of its original stretched dimensions upon activation, is said to be sharply corrugated, resulting in a lack of structural rigidity needed for more demanding applications. The tapes disclosed are intended simply as devices for securing wire and cable bundles, and the like.

U.S. Pat. Nos. 3,574,109 and 3,655,502 disclose heat insulating laminates in which at least one metal foil and at least one thermoplastic resin film are bonded at a number of bonding points uniformly distributed throughout the surface. The material is heated to cause shrinkage of the resin film and wrinkling of the metal foil.

U.S. Pat. No. 3,796,307 discloses a corrugated package material in which corrugated fluting is attached to one or more sheets of heat shrinkable polymeric film. The heat shrinkable film is preferably on only one side of the corrugated fluting, but may be on both sides of the corrugated fluting. The package may be heated to shrink the polymeric film and tighten the corrugated fluting core.

U.S. Pat. No. 6,875,712 discloses a shrinkable protective material that includes a nonwoven fabric bonded to a shrinkable film by an adhesive that is applied to either the nonwoven fabric or the shrinkable film in a pre-determined pattern. Upon shrinking, the nonwoven fabric separates or releases from the film and forms cushions or pillows holding the film off of the surface being protected.

U.S. Pat. No. 7,588,818 discloses a multi-layer composite sheet comprising a shrinkable layer intermittently bonded to a gatherable layer with the bonds separated by a specified distance, wherein the shrinkable layer can shrink and at the same time gather the gatherable layer between the bonds. Also disclosed is a process for preparing multi-layer composite sheets by intermittently bonding a shrinkable layer to a gatherable layer with the bonds separated by a specified distance and causing the shrinkable layer to shrink while at the same time gathering the gatherable layer between the bonds.

JP 6-115014A discloses a laminatable strip that has self-stretching properties and can be filled with gas on site without the use of an expanding gas or the like, wherein the strip is a highly self-stretchable strip that has an ultrahigh gas content and a stable structure after stretching.

JP 6-238800A discloses a laminate for forming a three-dimensional structure with holes wherein a low-heat-shrinkage sheet and a high-heat-shrinkage sheet are alternately laminated together via partially adhesive layers arranged at a pre-determined interval in a substantially striped pattern substantially perpendicular to the shrinkage direction of the high-heat-shrinkage sheet, the laminate being characterized in that the low-heat-shrinkage sheet and the high-heat-shrinkage sheet are laminated in at least five layers or more. Working Example 1 uses a 100 um paper core and a 40 um PVC shrink film exhibiting 50% shrink, with a 30 mm bond spacing. The resulting “corrugation ratio” based on literature values for PVC and paper, as further discussed below, is estimated to be about 0.014. We have found that values that give the best performance are between 0.02 and 0.9 based on our experiments. Being on the low side of this range means the shrink force is too high relative to the buckling resistance of the core such that overbuckling/wrinkling typically occurs.

A related patent document having the same inventor and filing date, JP 6238796, discloses a three-dimensional arcuately formed laminated body, said to be useful for obtaining a strong and stable three-dimensional structure, that is made from a low-heat-shrinking sheet and a high-heat-shrinking sheet alternatingly laminated such that there exists a difference in shrinkage between the sheets in the vertical direction, the sheets being interposed by a plurality of substantially striped partial adhesive layers disposed at a specific spacing. The laminated body is characterized in that the low-heat-shrinking sheet and the high-heat-shrinking sheet are five or more layers in total, and the partial adhesive layers are disposed alternatingly on an obverse and reverse side of the low-heat-shrinking sheet such that the spacing sequentially increases or decreases.

There remains a need in the art for improved film laminates that are easily produced and shipped, that may be formed and shipped as rolls and that may be processed prior to use to form corrugated structures.

### SUMMARY OF THE INVENTION

The invention thus relates to self-corrugating laminates. In one aspect, the self-corrugating laminates include an upper and a lower shrinkable film layer each having at least one axis of shrinkage and a non-shrinkable core having a top surface and a bottom surface and bonded between said upper and lower shrinkable film layers along in bond lines. The bond lines that bond the upper shrinkable film layer to the top surface of the non-shrinkable core are staggered relative to the bond lines that bond the lower shrinkable film layer to the bottom surface of the non-shrinkable core. Upon shrinkage of the shrinkable film layers, a corrugated structure including structural corrugations in the non-shrinkable core is formed. At least a portion of the bond lines are arranged substantially perpendicular to an axis of shrinkage of the shrinkable film layer to which the bond lines are attached. The shrinkable film layers of the invention typically exhibit a percent shrinkage along an axis of shrinkage from about 10 to about 45 percent. Alternatively, the shrinkable film layers may exhibit a percent shrinkage, for example, from 15 to 35 percent, or from 20 to 30 percent, or as disclosed elsewhere herein.

In one aspect, the difference in shrinkage percent between the upper and lower shrinkable film layers is no more than 10%. In another aspect, the difference in shrinkage percent between the upper and lower shrinkable film layers is at least 10%, such that the resulting corrugated structure upon shrinkage of the shrinkable film layers is substantially curved, as further described below.

In one aspect, the self-corrugating laminates of the invention exhibit a corrugation ratio less than 1, before shrinkage of the shrinkable film layers, according to the following formula (1):

$$\frac{1}{3} * \frac{{π}^{2} {E}_{c} {h}_{c}^{3}}{{P}_{o}^{2} σ {h}_{s}} < 1 \qquad ( 1 )$$

wherein hc is the non-shrinkable film layer thickness, Ec is the modulus of the non-shrinkable film layer, Po is the spacing between adhesive bond lines prior to activation of shrinkage of the shrinkable film layers, σ is the shrink stress upon shrinkage of the shrinkable film layers (measured according to the method set forth below), and hs is the thickness of the shrinkable film layers. Ec and a both have units of force over area (e.g. Pascals) whereas hc, hs and Po have units of length (e.g. mm), thereby making the equation dimensionless.

In a further aspect, corrugated structures formed from the self-corrugating laminates of the invention exhibit an aspect ratio Hc/P of from about 0.1 to about 0.8, according to the following formula (2):

0.1<Hc/P<0.8 (2)

wherein Hc is the height of the corrugated core layer and P is the line bond spacing after shrinkage. Preferably, the aspect ratio may be from 0.2 to 0.6, or as disclosed elsewhere herein.

According to the invention, the upper and lower shrinkable film layers of the self-corrugating laminates of the invention may comprise any of a number of polymers or polymer blends, including those from a polyester, a copolyester, an acrylic, polyvinyl chloride, polylactic acid, a polycarbonate, a styrenic polymer, a polyolefin, a polyamide, a polyimide, a polyketone, a fluoropolymer, a polyacetal, a cellulose ester or a polysulfone. In certain aspects, the shrinkable film layers may be comprised of one or more of a polyester, a copolyester, a polycarbonate, an acrylic, or a styrenic polymer.

The bond lines of the self-corrugating laminates of the invention may be formed in a number of ways, and may thus comprise an adhesive, a heat-weld, or a solvent-weld, for example. The non-shrinkable core may optionally include one or more flutes to assist in forming corrugations in the non-shrinkable core upon shrinkage of the shrinkable film layers.

The self-corrugating laminates of the present invention are useful in forming corrugated structures that include a non-shrinkable core with structural corrugations therein. Structural corrugations are formed in the non-shrinkable core by shrinkage of the shrinkable film layers. The resulting corrugated structure has a thickness, H, that can vary within the structure due to differences in the bond line spacing P, the ratio of the maximum value of P to the minimum value of P within the resulting structure being 1.1 or greater, or 1.2 or greater, or 1.5 or greater, or as disclosed elsewhere herein.

In one aspect, as further described herein, the self-corrugating laminates of the invention have a non-shrinkable core that includes multiple layers of non-shrinkable film.

Further aspects of the invention are as disclosed and claimed herein.

### BRIEF DESCRIPTION OF THE DRAWINGS

FIG. 1 depicts a cross-section of a self-corrugating laminate of the present invention.

FIG. 2 depicts a cross-section of a corrugated structure formed from a self-corrugating laminate of the present invention.

FIG. 3 depicts a three-dimensional elevational representation of a corrugated structure made from a self-corrugating laminate of the present invention

FIG. 4 depicts a cross-section of a curved corrugated structure made from a self-corrugating laminate of the present invention that includes upper and lower shrinkable film layers with differing shrinkages.

FIG. 5 depicts a cross-section of a corrugated structure formed from a self-corrugating laminate of the present invention that includes varied bond line spacing.

FIG. 6 is an exploded elevational view of a self-corrugating laminate of the present invention by which a radially symmetric corrugated structure may be formed.

FIG. 7 is a cross-section of another embodiment of the self-corrugating laminate of the present invention.

### DETAILED DESCRIPTION

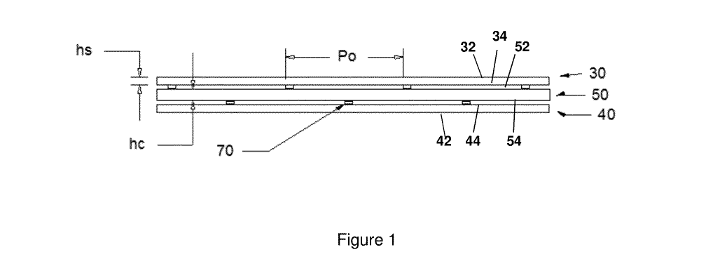

Attention is directed to FIG. 1 of the drawings, which depicts in cross-section an embodiment of the self-corrugating laminate of the present invention (not shown to scale). In this embodiment, the present invention thus relates to a self-corrugating, substantially flat laminate that includes three layers in an “A/B/A” configuration: a non-shrinkable core 50 including a top surface 52 and a bottom surface 54 sandwiched between and bonded along bond lines 70 to a first (or upper) and second (or lower) shrinkable film layers 30 and 40 each having an axis of shrinkage. Axis of shrinkage, as used herein, is intended to describe the general direction of the shrinkage of the shrinkable film layers. Shrinkable film layer 30 includes outer surface 32 and inner surface 34 while shrinkable film layer 40 includes outer surface 42 and inner surface 44. The shrinkable film layers have a thickness, hs, whereas the non-shrinkable core has a thickness equal to hc. At least a portion of the bond lines 70 are arranged substantially perpendicular to the axis of shrinkage of their adjacent, connected shrinkable film layer. More specifically, at least portion of bond lines 70 along which shrinkable film layer 30 is bonded to non-shrinkable core 50 are arranged substantially perpendicular to the axis of shrinkage for shrinkable film layer 30. Similarly, at least portion of bond lines 70 along which shrinkable film layer 40 is bonded to non-shrinkable core 50 are arranged substantially perpendicular to the axis of shrinkage for shrinkable film layer 40. As depicted, the axis of shrinkage generally corresponds to a horizontal shrinkage direction. Each of the shrinkable film layers 30 and 40 is bonded to the non-shrinkable core 50 along bond lines 70 with a periodic spacing Po, using for example adhesive or thermal type bonding.

The bond lines 70 that bond said the upper shrinkable film layer 30 at its inner surface 34 to the non-shrinkable core 50 at its top surface 52 are staggered relative to the bond lines 70 that bond said the lower shrinkable film layer 40 at its inner surface 44 to the non-shrinkable core 50 at its bottom surface 54 such that, upon shrinkage of the shrinkable film layers 30 and 40, a corrugated structure comprising structural corrugations in non-shrinkable core 50 is formed. Preferably, the bond lines 70 are staggered by a distance of approximately Po/2.

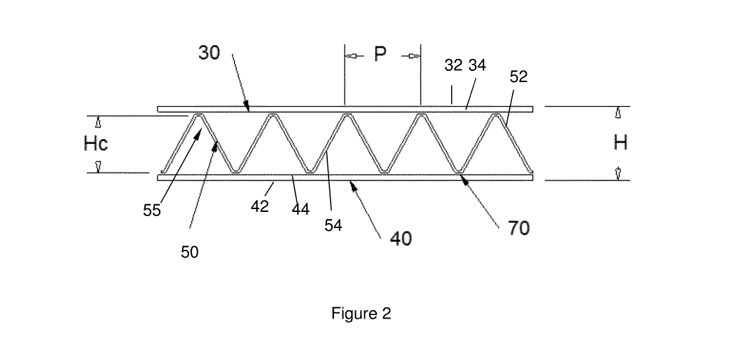

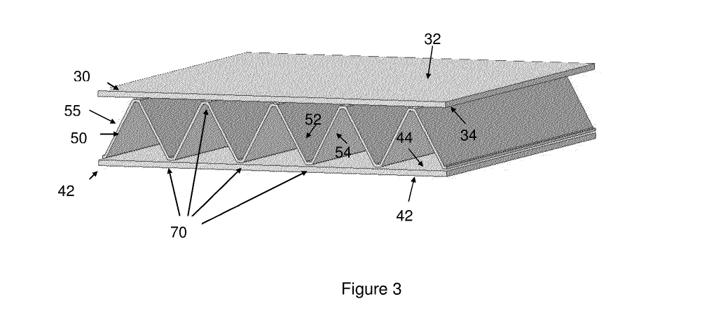

Attention is directed now to FIGS. 2 and 3, which depicts in cross-section and three-dimensional elevational views respectively a corrugated structure of the present invention having an “A/B/A” configuration. According to the invention, staggered bond lines 70 as described above help to drive the formation of structural corrugations 55 in non-shrinkable core 50 (FIGS. 2 and 3) by pulling adjacent portions of the core layer in different directions upon shrinkage of the shrinkable film layers 30 and 40. The final structure may have, for example, a new periodic spacing equal to, for example, P (P<Po), a total height equal to H and a height of corrugation equal to Hc. As further described herein, the initial bond spacing Po for the self-corrugating laminate is to be selected based on the geometry of the films during shrinkage of the shrinkable film layers in order to obtain structural corrugations without excessive wrinkling.

In one aspect, the invention thus relates to self-corrugating laminates that include upper and lower shrinkable film layers and a non-shrinkable core between said upper and lower shrinkable film layers and discontinuously bonded to each of the shrinkable film layers along bond lines. The self-corrugating laminates may optionally comprise repeating layers of a shrinkable film layer and a non-shrinkable core, each of which is discontinuously bonded to the adjacent layer along bond lines, for example with a shrinkable film layer as the top layer of the laminate, and another shrinkable film layer as the bottom layer of the laminate. Upon heating or otherwise causing the shrinkable film layers to shrink, the non-shrinkable core is formed into regular corrugations that are capable of providing structural support, described herein as structural corrugations. The laminates described may be used, for example, to form structural corrugated articles or three-dimensional structural corrugate articles having, for example, a honeycomb form.

In another aspect, described in more detail below, a functional, non-shrinkable film or core layer is bonded intermittently between two shrinkable film layers in a staggered or discontinuous fashion using bond lines. Upon shrinking, for example by heating heat-shrinkable film layers, the shrinkable film layers of the invention pull the structure into a three-dimensional corrugated structure. The resulting structure can be used for a wide variety of applications (for example. structural or thermal) based on the form of the functional core or non-shrinkable film layer. Curved structures are also possible by appropriate selection of parameters such as for example the relative shrinkage on the shrinkable film layers and bond line spacing.

Unless otherwise indicated, all numbers expressing quantities of ingredients, properties such as percent shrinkage, corrugation ratio, and so forth used in the specification and claims are to be understood as being modified in all instances by the term “about.” Accordingly, unless indicated to the contrary, the numerical parameters set forth in the specification and claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C1 to C5 hydrocarbons”, is intended to specifically include and disclose C1 and C5 hydrocarbons as well as C2, C3, and C4 hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

As used herein, the term “shrinkable film layer” means a film layer that is capable of shrinking upon exposure to, treatment with or removal of a given condition or stimulus, for example elevated temperature or radiation (heat shrinking) or moisture (moisture induced shrinking) or force (release of a tensional force holding an elastomeric material in a stretched condition). The term is not intended to be especially limiting, although we have found, as further described below, that a surprisingly small amount of shrinkage yields the best results in terms of uniformity of the structural corrugations obtained. As further set out below, the shrinkage may be substantially uniaxial as achieved by a shrinkable film layer with a single axis of shrinkage, or may be biaxial, or may vary throughout the shrinkable film layer, such variation being matched to corresponding variations in the placement of the bond lines used to bond the shrinkable film layers to the non-shrinkable core. The bond lines will typically be placed substantially perpendicular to an axis of shrinkage of the adjacent connected shrinkable film layer, as further described herein. Any suitable film capable of shrinking, for example heat shrinkable film, may be used according to the invention, as further described herein. While the shrinkable film layer is preferably formed from a continuous film, it should be understood that the shrinkable film layer may also be formed from discontinuous materials such as nonwoven or woven webs capable of suitable shrinking.

As used herein, the term “non-shrinkable core” is not intended to exclude substrates that shrink, but rather, to describe substrates that shrink, if at all, substantially less than do the shrinkable film layers. In some embodiments, the non-shrinkable core may not shrink appreciably during use, while in others the non-shrinkable core may shrink to some extent, either uniformly or to correspond to a desired final shape which is obtained in combination with the appropriate selection for spacing and placement of bond lines. In various aspects, the amount of linear shrinkage of the non-shrinkable core may be less than about 10%, or less than 5%, or less than 1%, or as further set out herein. It should be evident that the non-shrinkable core will shrink substantially less than at least one of the adjacent shrinkable film layers so that the desired structural corrugations may be formed in the core.

As used herein, the term “bond lines” means continuous or discontinuous bonding which is generally linear or curved, and may be a continuous line or a noncontinuous line, for example a line or curve comprised of spot welding, arranged with respect to adjacent bond lines either parallel, substantially parallel, radially, or annularly. By the use of the term “bond lines” to describe bonding of shrinkable film layers to the non-shrinkable core, we do not mean that the non-shrinkable core must be bonded along a continuous line, but can optionally instead be “spot-welded” to the shrinkable film layers, so long as the bonding is generally linear or curved, as described herein. Spot welds are acceptable, but they preferably are reasonably close together so that distortion does not occur upon shrinkage of the shrinkable film layers.

As used herein to describe the relationship between bond lines and axes of shrinkage, the term “perpendicular” means that the angle of intersection between a bond line and an intersecting axis of shrinkage is approximately 90 degrees at the point of intersection, though it will be understood by one of ordinary skill that, for embodiments where for example bond lines are curved and/or shrinkage axes are radial, the angle of intersection may vary slightly.

It will be evident that at least a portion of the bond lines are arranged substantially perpendicular to an axis of shrinkage of their adjacent connected shrinkable film layer so that the bond lines will help form structural corrugations in the non-shrinkable core as the shrinkable film layer(s) shrink.

When we describe the corrugated structure of the present invention, we mean the structure formed from the self-corrugating laminate of the present invention.

As used herein, the term “structural corrugations” or “structural corrugates” means corrugations formed from the non-shrinkable core due to the shrinking of the shrinkable film layers which draw the non-shrinkable core into corrugations that are capable of providing structural support. These structural corrugations are to be distinguished from weak and typically irregular and/or wavy lines that may be suitable, for example, to provide an insulating layer or bulk in cases where structural support is not required, and the corrugations need not therefore be carefully controlled as is done according to the present invention. Although the prior art has in some cases depicted in idealized drawings corrugations that appear to be regular and substantial, and thus theoretically and potentially useful to provide structural support, we have found that such disclosures are deficient in disclosing how such a regular pattern with sufficient structural support could be obtained. This discussion of corrugations is further elaborated on below with respect, among other things, to the aspect ratio (Hc/P).

When we say that shrinkage is “substantially perpendicular” to the bond lines or that at least some bond lines are “substantially perpendicular” to an axis of shrinkage, we mean that the bond lines and the axis of shrinkage are sufficiently perpendicular to one another in a given area of the laminate so as to obtain the desired shape in the resulting corrugated structure. It will be understood that the axis of shrinkage is the general direction in which the length of the shrinkable film layer changes during shrinkage.

Thus, for the embodiment of the present invention wherein a shrinkable film layer is substantially uniaxial, at least a portion and preferably a substantial portion of the bond lines bonding that shrinkable film layer to the non-shrinkable core will be placed substantially perpendicular to the axis, or similarly the direction of maximum shrinkage for that shrinkable film layer. If a shrinkable film layer is biaxial or polyaxial, in which a given area of a shrinkable film layer changes length upon shrinkage along more than one axis, both or all of the axial directions of shrinkage will be taken into account in placing the bond lines. Typically this means that the bond lines will be perpendicular to one or both shrink axes.

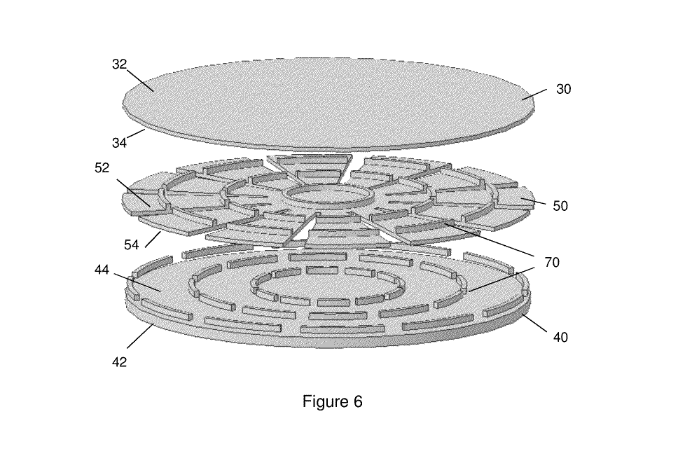

In the case of equibiaxial films that are stretched approximately equal amounts in the x and y direction, the shrinkage behavior is identical to that of a “radially” stretched film. In other words from any arbitrary point in the film, all other points will move radially inwards towards that point by the same amount during shrinkage. This can be illustrated by drawing a circle on a piece of equibiax film prior to shrinkage, and noting that the diameter gets smaller during shrinkage, but the shape otherwise remains constant. In contrast, this same circle drawn on a uniaxial shrink film will appear to be “squashed” along the shrink axis thereby forming a more ellipsoidal final shape. Similarly, non-equibiax films will form ellipsoids of various shapes and aspect ratios depending on the relative shrinkage in the x and y directions. Because it is preferred that the bond line always be normal to the direction of maximum shrinkage, for equibiaxial films the bond lines would typically need to curve. Consequently, bond lines in a biax film will preferably be placed in a circular or annular layout in relative to the center of the structure so that the bond maintains this perpendicular relationship to this direction of maximum shrinkage. By way of example, the embodiment of the invention set out in FIG. 6 includes bond lines that are perpendicular to the maximum direction of shrinkage and are thereby arranged annularly to obtain a bowl-like shape in the resulting corrugated structure. Those skilled in the art in light of the present disclosure will be able to determine where to place the bond lines given the nature of the shrinkable film layer selected and the shape that is desired to be obtained.

According to one aspect of the invention, an unexpected discovery is that relatively low amount of shrinkage in the shrinkable film layers can achieve substantially uniform structural corrugations in the non-shrinkable core. Shrinkage of a shrinkable film layer along a given axis of shrinkage, can be defined as the percentage of change in length in that direction using the following formula:

Percent shrinkage=(Lo−L)/Lo*100 (3)

wherein L is the length of the film after shrinkage, and Lo is the length prior to shrinkage in the same units as L. Shrinkage as quantified above refers to the amount of shrinkage obtainable in a single direction and may be measured for example in heat-shrinkable film by heating the film to a temperature sufficiently above the Tg (or Tm) to allow substantially complete recovery of the film. By the term “length,” we mean generally the machine direction in which, for example, a heat-shrinkable film layer was formed, although such a film may be stretched biaxially or radially, for example, and the bond lines associated with the film laid out substantially perpendicular to the direction in which the film is stretched (and therefore its direction or axis of shrinkage). See generally FIG. 6. The length may thus be in the shrinkage direction of axis of shrinkage for uniaxial film and either or both directions when biaxial film layers are described. Thus, when round or rounded structures are desired, the intended shrinkage may be equibiaxial or radial. Note that for biaxial shrinkable film layers, at least some bond lines may be perpendicular to one shrinkage axis, but not necessarily the other, due to the nature of shrinkage of such film layers.

Although most commercial shrink films used for packaging have an ultimate or total shrinkage of 60 to 80%, we surprisingly found that the relatively high shrinkage from these conventional films when used as the shrinkable film layers of the present invention produces poorly formed and uncontrolled corrugations in the non-shrinkable core (i.e. “wrinkling” or “overbuckling”) and thus was not acceptable. In contrast, the percent shrinkage of the shrinkable film layers may be, for example, less than 45%. As a result of much experimentation and analysis, it was unexpectedly discovered that, depending in part on the physical and chemical parameters of the non-shrinkable core, a defined range of shrinkage in the shrinkable film layers (as quantified by percent shrinkage) could produce particularly useful corrugated structures. For example, shrinkable film layers having a percent shrinkage in the range of about 8% to about 48%, preferably 10 to 45%, more preferably 10 to 42%, even more preferably 15 to 35%, and even more preferably 20 to 30% produced generally uniform corrugations in the non-shrinkable layer. Outside of these shrinkable film layer parameters either wrinkling or insufficient buckling of the non-shrinkable core may occur, such that it is difficult to create stable and consistent structural corrugations. Even in cases where we were able to achieve temporarily acceptable structures using higher shrinkage shrinkable film layers by only partially shrinking the shrinkable film layers, the resulting structures were not thermally stable as any additional heating would cause the corrugation to be disrupted.

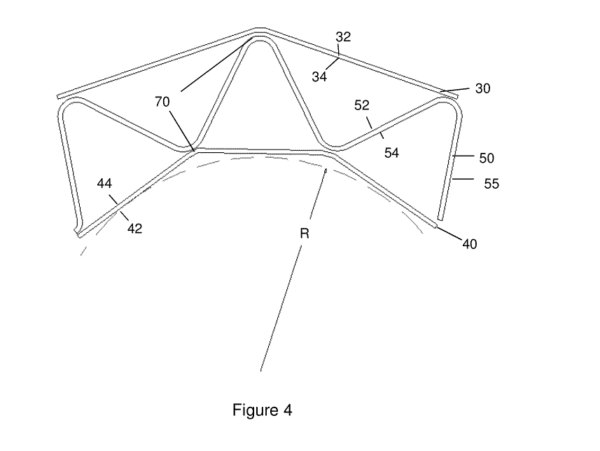

We note that the shrinkable film layers need not exhibit the same percentage of shrinking, especially if curved corrugated structures are desired. In one embodiment with an upper shrinkable film layer having about 10% shrinkage and a lower shrinkable film layer having about 20% shrinkage, the resulting corrugated I structure is curved in shape due to the difference in percent shrinkage of the two shrinkable film layers. See, for example, FIG. 4. In such cases, differential shrinkage is an important aspect of obtaining curved structures. The difference in shrinkage between the layers can thus be varied to adjust the radius of curvature of the resulting corrugated structure.

“Shrink stress” as used herein is defined as the maximum retraction force exhibited by the shrinkable film when subjected to shrinking conditions divided by the initial cross-sectional area of the film. Shrink stress is measured according to the following procedure: a sample strip of film 1 inch (25.4 mm) wide is mounted in a tensile tester apparatus such that slack is removed. The film sample then rapidly heated to above the Tg of the polymer from which the film is formed and the maximum force recorded. The shrink stress is the maximum force divided by the initial cross-sectional area of the film strip.

For a given material, shrink stress increases with shrinkage, and predictive models for this relationship already exist (e.g. Mooney-Rivlin and neo-Hookian models). A certain shrink force will be needed to achieve uniform buckling of the non-shrinkable core of the present invention; however, too high shrinkage may cause “overbuckling” of the core and poorly defined corrugation. Finding and quantifying the right balance between these competing factors was therefore a significant aspect of the invention. Accordingly, selection of shrinkable film layers exhibiting the appropriate shrink stress for a given non-shrinkable core is important.

According to this aspect of the invention, it has been discovered that the balance between the buckling resistance of the non-shrinkable core and the amount of shrink force being applied by the shrinkable film layers can be quantitatively represented by a parameter referred to herein as “corrugation ratio”. The formula for the corrugation ratio is as follows:

$$\frac{1}{3} * \frac{{π}^{2} {E}_{c} {h}_{c}^{3}}{{P}_{o}^{2} σ {h}_{s}} \qquad ( 4 )$$

wherein hc is the non-shrinkable core thickness, Ec is the modulus of the non-shrinkable core, Po is the spacing between adhesive bond lines prior to activation of shrinkage of the shrinkable film layers, σ is the shrink stress upon shrinkage of the shrinkable film layers, and hs is the thickness of the shrinkable film layers. It will be understood by one of ordinary skill that each of the above variables are to be expressed in units selected such that said corrugation ratio is dimensionless. For example, units for the modulus and shrink stress are in force per unit area (e.g. Pascals) whereas hc, hs and Po are all in units of length (e.g. mm). For the self-corrugating laminates of the present invention, the corrugation ratio is preferably less than 1:

$$\frac{1}{3} * \frac{{π}^{2} {E}_{c} {h}_{c}^{3}}{{P}_{o}^{2} σ {h}_{s}} < 1 \qquad ( 1 )$$

The core layer buckling resistance is a function of the core layer thickness hc, the modulus of the core Ec, and the spacing between adhesive bonds Po. The shrinkage force, in turn, is a function of the shrinkage stress σ and the thickness of the shrinkable film layers hs. Note that shrink stress is a property of the shrinkable film layers and is dependent on both the material and the stretching conditions used to make the shrinkable film layers. For example, very high shrinkage film will usually have very high shrink stress analogous to the force of a rubber band when stretched. Shrink stress is typically constant for a given roll of film and most commercial shrink films have fairly well-defined values. The shrink force, on the other hand, is equal to the shrink stress multiplied by the cross sectional area of the film (i.e. thickness×width). So for films with lower shrink stress (e.g. low shrinkage films like those described herein), we may compensate by using thicker films to keep the shrink force high enough to achieve buckling and corrugation of the non-shrinkable core. According to this aspect of the invention, if the above relationship between layer thicknesses, bond spacing, core modulus and shrink stress is met, then there exists the appropriate shrink force to induce satisfactory buckling.

More preferably, the corrugation ratio is between 0.02 and 0.9:

$$0.02 < \frac{1}{3} * \frac{{π}^{2} {E}_{c} {h}_{c}^{3}}{{P}_{o}^{2} σ {h}_{s}} < 0.9 \qquad ( 5 )$$

We have observed that if the corrugation ratio is below about 0.02, the forces are generally too high relative to the buckling strength of the core and poor corrugation uniformity results. More preferably, the corrugation ratio is from 0.05 to 0.8, and most preferably from 0.1 to 0.75.

If the above conditions with respect to the corrugation ratio are met, uniform and strong corrugated structures may be created having corrugations with a substantially sinusoidal aspect ratio. The aspect ratio, in this case, is the ratio Hc/P where Hc is the height of the corrugated non-shrinkable core and P is the line bond spacing after shrinkage with the units for Hc and P being the same. (i.e. Hc is twice the amplitude of the sine wave represented by the corrugation and P is the corrugation wavelength). If Hc/P is too large, then the resulting corrugation is very “tall” and closely packed together resulting in a more unstable structure. In this case, compressive strength (i.e. top load) is adequate but shear resistance is poor. Similarly, if Hc/P is too low, the corrugation is too shallow and widely spaced and provides little compressive strength from top loads (but good shear resistance).

For the present invention, it is preferred that for the resulting corrugated structure the aspect ratio be from about 0.1 to about 0.8 according to the following formula:

0.1<Hc/P<0.8 (2)

A preferred range for the aspect ratio is from 0.2 to 0.6, as this range is applicable to a corrugated structures formed from a range of shrinkable film layer percentages of about 15% to about 45%.

According to the invention, the bond lines that bond the non-shrinkable core to an adjacent shrinkable film layer may be arranged with respect to one another either parallel or substantially parallel, or radially or annularly from a given point, depending upon the desired shape of the final structure once shrinkage has occurred. Each of the shrinkable film layers is bonded to the adjacent non-shrinkable core along bond lines laid out with respect to one another, for example, in parallel, substantially parallel, radial, or annular configuration, with a periodic spacing of approximately Po, using, for example, an adhesive, solvent welding, or thermal-type bonding. Furthermore, the bond lines that bond the upper shrinkable film layer to the top surface of said the non-shrinkable core are staggered relative to the bond lines that bond the lower shrinkable film layer to the bottom surface of the non-shrinkable core such that upon shrinkage of the shrinkable film layers a corrugated structure comprising structural corrugations in the non-shrinkable core is formed. This staggered bonding helps to drive the formation of the corrugated structures as depicted for example in FIGS. 2 and 3, by alternately pulling portions of the core non-shrinkable film layer in different directions.

The present invention thus provides a way to make corrugated structures from a preformed, preferably substantially flat self-corrugating laminate that preferably can be rolled for ease of shipping and then unrolled and processed to form corrugated structures only when needed. Because the non-shrinkable core may be selected from a variety of materials or modified to perform a variety of functional characteristics, a variety of different functional corrugated structures can easily and inexpensively be produced for a wide range of different applications. For example, the non-shrinkable core may be printed to produce aesthetically pleasing panels, or used for electrical applications (e.g. built in wiring or electromagnetic shielding). The functionality of the non-shrinkable core may thus be easily selected and remains protected from the environment by the shrinkable cap layers.

The present invention may thus be used to form corrugated structures from self-corrugating laminates that include thermally shrinkable materials. Prior to activation of the shrinkage of the shrinkable film layers, the films may be in a substantially flat, non-corrugated form, which may be easily wound on a roll.

As noted, the shrinkable film layer may be selected from a variety of polymer components having selected physical properties such as glass transition temperature (Tg), tensile modulus, melting point, surface tension, and melt viscosity.

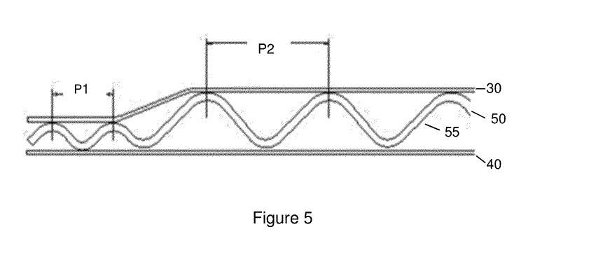

It will be understood that the spacing of the bond lines need not be uniform. Thus, in one aspect, the thickness of the resulting structure H upon shrinkage of the shrinkable film layers may differ within the structure due to differences in the bond line spacing P. See, for example, FIG. 5. The ratio of the maximum value of P to the minimum value of P within the resulting structure may thus be, for example, 1.1 or greater, or 1.2 or greater, or 1.5 or greater.

A variety of materials may be used for the shrinkable film layers and the non-shrinkable core. For example, the non-shrinkable core may be a plastic film such as a copolyester, polyester, acrylic, olefin, polycarbonate, polyimide, polyamide, styrenic, acetal, cellulose ester, urethane etc. It may be formed from a thermoset or a thermoplastic plastic, but is not limited to plastics, and may also be a metal foil, paper, a nonwoven, a fabric, and so forth. The non-shrinkable core may also be selected or modified to provide a desired functionality. For embodiments wherein shrinkage of the shrinkable film layers is activated by elevated temperature. It is preferred that the non-shrinkable core be formed from a material having a softening temperature near to or above the temperature of shrinkage of the shrinkable film layers. This is to prevent undesirable deformation of the core due to premature softening during the corrugation process. For non-shrinkable cores formed from plastic, this softening temperature is usually denoted by the glass transition temperature Tg, or the melt temperature Tm.

The shrinkable film layer may be selected from a range of polymers and may comprise a single polymer or a blend of one or more polymers. Non-limiting examples of polymers which may comprise the shrinkable film layer may include one or more polyesters, polylactic acid, polyketones, polyamides, fluoropolymers, polyacetals, polysulfones, polyimides, polycarbonates, olefinic polymers, or copolymers thereof.

In a preferred embodiment, shrinkage of the shrinkable film layers is activatable by elevated temperature or heating. In this embodiment, the shrinkable film layer is typically oriented. The term “oriented”, as used herein, means that the shrinkable film layer is stretched to impart direction or orientation in the polymer chains. The shrinkable film layer, thus, may be “uniaxially stretched”, meaning the shrinkable film layer is stretched in one direction, or “biaxially stretched,” meaning the shrinkable film layer has been stretched in two different directions, typically but not always substantially perpendicular. For example, in the case of a film, the two directions are in the longitudinal or machine direction (“MD”) of the film (the direction in which the film is produced on a film-making machine) and the transverse direction (“TD”) of the film (the direction perpendicular to the MD of the film). Biaxially stretched articles may be sequentially stretched, simultaneously stretched, or stretched by some combination of simultaneous and sequential stretching.

The specific properties of the shrinkable film layer depend in part on and can be controlled in part by manipulating the stretching time and temperature and the type and degree of stretch. The stretching typically is done just above the glass transition temperature (e.g., Tg+5° C. to Tg+60° C.) of the polymer from which the film is formed.

In another embodiment, one or more of the thermally activated shrink layers can be replaced by a stretchable material such as rubber. This can include material like natural rubber, styrene-butadiene rubber, thermoplastic elastomers and the like. In this embodiment, the shrinkable film layer is manually held in a stretched configuration while bonding occurs. Instead of heating this layer, the restraint need only be released to cause corrugation. The shrink stresses and corrugation performance of a stretch layer are otherwise identical to thermally activated shrink sleeves with regards to shrink stress, shrinkage effects, and so forth. In a similar manner, shrinkable film layers activated by other factors (e.g. moisture contact) are also envisioned.

The shrinkable film layers according to the invention may be formed from polyesters of various compositions. For example, amorphous or semicrystalline polyesters may be used which comprise one or more diacid residues of terephthalic acid, naphthalene-dicarboxylic acid, 1,4 cyclohexane-dicarboxylic acid, or isophthalic acid, and one or more diol residues, for example ethylene glycol, 1,4-cyclohexane-dimethanol, neopentyl glycol, or diethylene glycol. Additional modifying acids and diols may be used to vary the properties of the film as desired.

Construction of the self-corrugating laminates of the present invention and their components can be achieved using a variety of methods and materials. Typically, film or sheet extrusion may be used to create the non-shrinkable core. This can be achieved, for example, by cast extrusion, sheet polishing, blown film, calendering and the like. Typically, thicknesses will range from about 0.01 to 10 mm for the core or non-shrinkable layer, but even thicker values may be envisioned, particularly if the core is of lower modulus (e.g. foams, rubbery materials). The non-shrinkable core may also contain any of a number of conventional additives and processing aids, colorants, pigments, stabilizers, antiblocks, etc. as long as these do not materially adversely affect subsequent bonding of the non-shrinkable core to the shrinkable film layers. Multilayer coextruded or laminated structures can also be useful for the non-shrinkable core, particularly for embodiments wherein specified functionality in the corrugated structure is desired.

The non-shrinkable core may optionally have texture or thickness variations, imparted, for example by using lenticular casting rolls, embossing, or post-extrusion modification. Examples of thickness variation include (1) a thin spot or cut in the non-shrinkable coreat certain locations to allow for easier and more controlled buckling and (2) a continuous undulating variation imparted via lenticular embossing rolls. Having thin spots or grooves in the core, particularly on the opposing side from a bond line, can allow the core to buckle during corrugation formation with less shrink force. This may be advantageous particularly with very thick cores. Grooves and embossed patterns can also be beneficial for aiding bonding along bond lines formed with ultrasonic staking.

For embodiments wherein bond lines are formed with adhesives or solvents, grooves can be added to the non-shrinkable core to help keep the adhesive or solvated material within a specific area and prevent “squeeze-out” when the layers are pressed together in forming the self-corrugating laminate as described below. Other modifications to the non-shrinkable core such as pre-creasing, slitting, scoring, die-cutting, thermal pre-forming and the like might also aid in guiding the corrugation of the core in some applications. Similarly, the use of selective heating to soften certain defined areas points of the non-shrinkable core might be beneficial as softening the material has the same effect as reducing the local thickness. Selective heating might also be achieved using dyes or other electromagnetic radiation absorbers that are selectively added or printed on certain sections of the non-shrinkable core to make these regions heat up more. In one embodiment, adhesive used in forming bond lines is modified to be more absorbent to radiation thereby reducing the modulus of the core at the point of contact with the bond line and allowing buckling at a lower shrink stress.

The shrinkable film layers of the present invention are produced from known or conventional materials as exemplified above and which are or can be modified or treated to be capable of shrinkage. In the preferred embodiment wherein shrinkage of the shrinkable film layers is activatable by elevated temperature or heating, the shrinkable film layers will be oriented film. Orientation of the shrinkable film layers can be achieved by conventional means, for example stretching on a tenter, drafter, via use of known blown film processes or by calendering. Oriented films for the shrinkable film layers of the present invention can also be formed using a cast line run at relatively high draw down speeds with subsequent rapid quenching of the film.

The shrinkable film layers can be oriented uniaxially or biaxially, and the biaxial orientation can be equibiax or non-equibiax. Uniaxial orientation results in a singular axis of shrinkage and is preferred for producing corrugated structures with corrugation in substantially one direction, whereas biaxially oriented films can be used to produce, for example, radially symmetric type structures (e.g. bowls). Non-equibiax films that stretch a different amount in each of two different directions, can be useful for creating unusually curved corrugations.

In assembling and constructing the self-corrugating laminate of the present invention, the shrinkable film layers are discontinuously bonded to the non-shrinkable core along bond lines. In order to generate the desired structural corrugations in the non-shrinkable core upon shrinkage of the shrinkable layers, the bond lines that bond the upper shrinkable film layer to the top surface of said non-shrinkable core are staggered relative to the bond lines that bond said lower shrinkable film layer to said bottom surface of said non-shrinkable core. Typically, the resulting laminate has an “A/B/A” configuration where A represents the shrinkable film layers and B is the non-shrinkable core. It is understood that the non-shrinkable core may include multiple layers, in particular when the process of making the self-corrugating laminate includes a step of forming two or more “pre-lams” including a shrinkable film layer and a non-shrinkable film layer as described below. This bonding can be performed by any number of batch, semicontinuous or continuous methods. For example, the self-corrugating laminate may be constructed using a continuous process (e.g. a roll-to-roll process) that includes feeding the non-shrinkable core from a roll between upper and lower shrinkable film layers, also from rolls, to form an sheet assembly and bonding the top and bottom surfaces of the non-shrinkable core to the upper and lower shrinkable film layers respectively along bond lines by passing the assembly through a bonding station (e.g. a heat sealer or adhesive applicator). The resulting self-corrugating laminate could then be wound into a roll form for later use, or cut to length to form individual laminates. Alternatively, the laminate may be constructed using a manual/batch process such as a “cut and stack” operation that includes cutting heat shrinkable film material and non-shrinkable core material to form upper and lower heat shrinkable film layers and non-shrinkable core; forming a stack that includes the upper and lower heat shrinkable film layers with the non-shrinkable core therebetween; and bonding the top and bottom surfaces of the non-shrinkable core to the upper and lower shrinkable film layers respectively along bond lines. The bond or weld lines will be perpendicular or substantially perpendicular to an axis of shrinkage of the shrinkable film. For uniaxial shrinkable film, this means the bond line is approximately perpendicular to the direction of stretching/shrinking. For equibiax shrinkable films, the bond lines can be either radial or concentric or annular for radially symmetric structures, or in a variety of directions if the film shrinks equally in all directions (i.e. there is no single shrinkage direction). It is not required that all bonds be perpendicular to the shrinkage direction, as some can also be skewed. As may be recognized by one of ordinary skill, the less near to perpendicular to the direction of shrinkage, the less corrugation the bond lines will induce.

Bond lines may have a variety of configurations and be formed using a number of bonding methods. The bond can be in the form of a continuous line, or in a linear or curved pattern of “spot-welds”, or some combination of the two. Bonding can be achieved through traditional adhesives, such as with the use of epoxies, urethanes, cyanoacrylates, UV curable adhesives, and the like. It can alternatively be thermal in nature as induced by heat sealing, induction sealing, RF sealing, laser welding, or ultrasonic welding. It can be mechanical in nature such as by sewing or riveting. It can alternatively be induced by solvent welding. Methods like UV adhesive bonding and solvent welding have the advantage that the bond lines can be printed on using traditional printing methods (e.g. gravure). But these are also limited in that good adhesion/cohesion is required as well as compatibility between the film layers and the adhesive/solvent. Bonding can also be achieved by coating an entire surface the non-shrinkable core or a shrinkable film layer and selectively activating bonding along bond lines by energy field methods (e.g. laser or UV).

Because we are bonding multilayer structures in controlled patterns in forming the self-corrugating laminates of the present invention, it may also be desirable to utilize energy absorbers to focus heating in certain areas. For example, near-infrared absorbing additives are well known for use in polyester, and these could be added or printed on in specific locations, or only in certain layers, to focus heat only in key bonding areas. Similar additives exist for laser bonding and even dark inks/paints can cause significant localized absorption from high wattage heating lamps (e.g. quartz lamps). These can be selectively applied where localized heating is most desirable, otherwise most of the incident radiation passes through the structure. For electric-field-based systems like RF/microwave heating, metal susceptor films may be incorporated. These could be applied fpr example by printing onto the non-shrinkable core or a shrinkable film layer or pre-applied to a separate substrate to create a pre-form which then is laminated onto the core to focus radio-frequency absorption in certain areas. These pre-forms typically would take the form of thin strips or “wires” in the vicinity of where heating and bonding along bond lines is needed.

Thermal methods like RF sealing can produce extremely strong patterned bonds for bond lines but some of the methods are not conducive to producing staggered bond patterns in 3-layer A/B/A structures (unless extensive focusing/absorbing aids as described above are used). For example, RF sealing will try to bond all layers between the RF transducer and the ground plate which is not acceptable for the present invention.

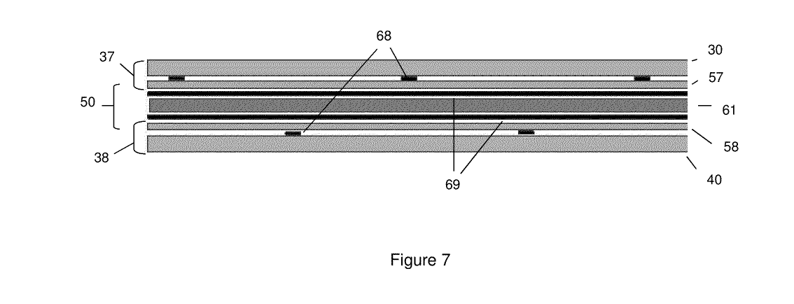

Consequently, an alternative embodiment of the present invention as shown in FIG. 7 includes the steps of forming two or more pre-lams that include a shrinkable film layer bonded to a nonshinkable film layer along bond lines and laminating the pre-lams together. In this method, a single roll of shrinkable film (A) and non-shrinkable film (B) is bonded along bond lines denoted by 68 using any of the above methods to create a pre-lam with an “A/B” configuration that preferably is wound onto a roll. Two rolls of this pre-lam A/B structure can then be laminated or adhered together to produce an A/B/B/A structure. Top layers A and B of a first pre-lam 37 are denoted by 30 and 57 respectively whereas the bottom layers of second pre-lam 48 are denoted by 40 and 58 respectively. In this case the two adjacent non-shrinkable layers B (B/B) 57 and 58 plus any optional adhesive 69 used to bond the layers together, constitutes the non-shrinkable core 50 for the overall corrugated structure. Even though the two A/B structures can originate from the same base roll of material, it is important to note that, for the resulting self-corrugating laminate, the bond lines that bond the upper shrinkable film layer to said top surface of said the non-shrinkable core must be staggered relative to the bond lines that bond said the lower shrinkable film layer to said the bottom surface of said non-shrinkable core, preferably by a distance of approximately Po/2. Lamination can be by any traditional method including using an extrusion/tie layer, an adhesive, solvent bonding etc. This embodiment allows for greater flexibility in producing very strong corrugated base materials.

In the embodiment described above and shown in FIG. 7, one or more additional non-shrinkable layers C denoted by 61 can optionally be included between non-shrinkable layers B 57 and 58 of the above to create an (A/B/C/B/A) structure. This C layer would be adhered to both non-shrinkable layers B 57 and 58 by any of the methods described previously with the adhesion or bonding layers denoted by 69. In this case, the non-shrinkable layers B and the non-shrinkable layer C between them (B/C/B structure) plus any adhesives used to bond the layers together, constitute the non-shrinkable core 50 for the overall structure. As an example, the non-shrinkable layer C could be a metallized or other functional film. Including such a film in between the two B layers has a number of advantages. First, the functional film is effectively encapsulated and protected which helps to minimize stresses that might otherwise damage the surface of the film (e.g. peeling of a metallized film surface). This is because the high localized stress associated with the staggered bond lines, is limited to just the A and B layer interface. In contrast, the C layer can be laminated to the B layers across any or all of its surface thereby greatly minimizing localized stresses. Another benefit is that the functionalized layer is often manufactured separately from the A and B layers, so this structure is the most convenient to produce from a logistics standpoint. A converter can laminate the films together in a final step and can swap out different functionalized layers as needed for different applications, all with minimal setup or changeover time.

The spacing between bonds Po can be varied over a wide range. Narrower bonds result in thinner total panel thickness (H) whereas wider spacing leads to thicker panels in general. The only restriction on spacing is the bonding method and shrink force imposed. Very narrow bonds (i.e. small Po) require higher shrink forces and impose more stress on the bond. Similarly, the lower limit on spacing is dictated by the minimum width of the adhesive bond line itself. For applications where very thin bond/weld lines are acceptable, very small values of Po can be used. Alternatively, selective heating/cooling of the layers can be performed (e.g. forced air on certain sections) to allow the core layer to be hotter/softer than the shrink layers and thereby minimize the amount of shrink force needed.

The self-corrugating laminates of the present invention are useful in in forming corrugated structures, defined herein as structures having at least one corrugated component. Another aspect of the present invention, therefore, is a method for forming a corrugated structure. This method of the present invention includes procuring, for example through manufacture or commercial transaction, a self-corrugating laminate of the present invention and subjecting the self-corrugating laminate to conditions sufficient to impart corrugation to the non-shrinkable core of the laminate. Preferably, the subjecting step includes exposing the shrinkable film layers of the self-corrugating laminate to a temperature sufficient to cause shrinkage of both shrinkable film layers. Typically, this temperature is a temperature at or above the shrinkage temperature of both shrinkable film layers assuming for convenience and without limitation that the shrinkable film layers are formed from the same material. By way of example, the temperature for the exposing step should preferably be in the range of Tg −10° C. to about Tg +30° C. where the Tg is for the shrinkable layer. Higher temperatures will also provide good quality corrugation, but greater care must be taken to ensure uniform heating in order to minimize curling/warping. If different materials are used in forming the shrinkable film layers, the temperature for the exposing step is preferably set based on the highest Tg between and amongst the shrinkable films.

While not required, it is generally preferred that the temperature of the exposing step employed in the method of the present invention not exceed the softening temperature of the materials from which the non-shrinkable core is formed. It can be important that the core be of consistent modulus during the process in order to ensure uniform corrugation. If, for example, the core Tg is similar the shrinkage temperature, then the core could be prone to softening and modulus variation which could result in uneven corrugation, unless very precise temperature control is employed. Generally, however, it is acceptable if the softening temperature of the non-shrinkable core is below the temperature employed in the method of the present invention.

The step of exposing the shrinkable film layers of the self-corrugating laminate to a temperature causing them to shrink can be effected by any suitable means and/or media known in the art, for example hot air exposure, immersion in a hot fluid, steam exposure etc. It is also possible to employ in the exposing step electromagnetic field methods such as IR, electromagnetic or conductive heating in embodiments where the shrinkable film layers are formed from a material sufficiently susceptible to temperature increases via an imposed energy source. By way of example, the presence of an IR absorber as a component of the shrinkable film layers might promote shrinkage of the shrinkable film layers when exposed to infrared heaters while leaving the non-shrinkable core at a relatively lower temperature.

For embodiments where a curved or otherwise shaped corrugated structure is desired, the process for forming the corrugated structure can further include shaping the corrugated structure. In a first embodiment the shaping step is performed simultaneously with the temperature exposure step, most preferably with the temperature exposure step performed in the presence of a mold or other shaping device which shapes the overall structure while not impacting the corrugation of the non-shrinkable core achieved by the temperature exposure step. In another embodiment, the shaping step is performed subsequent to the temperature exposure step. We have observed that a particularly suitable corrugated structure can be achieved when the laminate is placed in a hot mold and allowed to form with only very light mold pressure to guide the overall structure. In this situation, corrugation is activated by the elevated temperature of the mold and occurs simultaneously with molding as the overall structure softens and is pushed against the mold tooling. It will be understood by one of ordinary skill that composite corrugated structures that include two or more individual corrugated structures of the present invention may be contemplated. For example, a composite corrugated “stack” that includes multiple corrugated structures, with each corrugated structure formed from the self-corrugating laminate of the present invention, can be formed. The individual corrugated structures can be built together as a continuous stack or be individual corrugated structures laminated together. Furthermore, each structure in the stack can have differing geometries and/or preferred orientations from others. For example, one structure in the stack might be oriented perpendicular to another in a cross ply configuration, or at 45 degree angles in a bias ply in order to provide more flexural rigidity. Depending in part on the orientation of the individual structures, a stack can be may subjected to corrugation conditions as a single unit that incudes multiple corrugated structures. Alternatively, individual corrugated structures can be subjected to corrugation conditions separately and then bonded or laminated together to form a stack.

In one aspect, the core or non-shrinkable layer can be made functional in a variety of ways, and the shrink film layers then create the 3-D structure needed to make the functionality useful. Some of these will now be described.

In one embodiment, the corrugated structures obtained according to the invention can have curved surfaces (see FIG. 4). Curvature can be induced by guiding the laminates of the invention with molds while they are being corrugated or any time thereafter or by utilizing upper and lower shrinkable film layers having differing percent shrinkage. In FIG. 4, layer 40 has a greater shrinkage than layer 30. Typically, the radius of curvature denoted by R, can be controlled via the following kinematic relationship:

(100−x2)/(100−x1)=1+H/R (6)

where H is the total thickness of the structure, and x1 and x2 are the shrinkages (%) for layers 1 and 2 respectively. For example, if x1 and x2 are equal, R will approach infinity denoting a flat non-curving structure. Similarly, if x2 is larger than x1, a negative value of R results which indicates that the curvatures concave portion is facing the layer 2 side. The curvature of corrugation may be somewhat faceted in nature, but this faceting can be minimized by using smaller P spacing between bond points. In one aspect, only one shrinkable film layer need be applied to the non-shrinkable core in which case the other shrinkage value defaults to zero, resulting in highly curved or coiled structures.

It is preferred but not required that the self-corrugating laminate have a substantially flat configuration. In another embodiment, the core could already be in a non-flat or 3D configuration prior to assembling the self-corrugating laminate. This results in a substantially non-flat self-corrugating laminates that when processed into a corrugated structure might allow for even more unusual and curved corrugated structure shapes.

It may be understood that the initial spacing Po of bond lines may be used to control the thickness of the resulting corrugated structure. This can include having corrugated panels that change thickness with distance by increasing or decreasing the bond line spacing over the dimensions of the structure. For a given shrinkage, the thickness H of the structure will be directly dependent on bond line spacing. The wider the spacing of the bond lines, the thicker the final corrugated structure. This will allow for aesthetically pleasing curved surfaces that can be controlled simply by varying the bond spacing.

Radially symmetric parts as depicted in FIG. 6 can be produced using shrinkable film layers formed from biaxially oriented films. The upper and/or lower shrinkable film layers may optionally have a fluted core and concentric bond lines.

In this embodiment, bowl shaped corrugated structures can be created using concentric or annular rings of bond lines staggered between the top and bottom shrinkable film layers. Because the shrinkage pulls the material inward toward the center, the core material can tend to bunch up and retard proper corrugation. It has been found form this embodiment that the non-shrinkable core may include cutting flutes or cut-outs to better allow for formation of corrugations in the core. As the material shrinks and pulls in, the core flutes pull together and close the gap resulting in a more continuous structure. Otherwise the guidelines for producing corrugation are similar to those for uniaxial corrugation as described previously.

According to various embodiments, the non-shrinkable core layer can include or compose a number of functionalities. For example, the core can be printed or decorated to provide aesthetic properties. Distortion printing might be preferred to ensure proper artistic definition in the final corrugated structure. The shrinkable film layers could also include functionalities such as decorative printing for aesthetics.

The non-shrinkable core can also incorporate other features such as conduits, electrical conductive networks (e.g. flexible circuits), RF shielding via metallized coatings, fibrous structures for filtration, and so forth. These can be directly added into or onto the non-shrinkable core, or sections of the core could be removed prior to corrugation to allow for these features to be added. In one embodiment, flexible circuits consisting of etched copper coated polyimide could be laminated to portions of the non-shrinkable core to provide embedded wiring in the corrugated structure. In addition to the core layers, other separate components can also be integrated between the film layers prior to thermal application or corrugation.

The non-shrinkable core can also contain reinforcing materials such as fiber/flake reinforcement where structural applications are intended. These can be an integral part of the core or added on via adhesion or lamination. Various structural applications of the corrugated structure such as panels, furniture, partitions, etc. can be envisioned. Reinforcement within the shrinkable layers is also envisioned although it is understood that it cannot adversely affect the stretching/orientation process for making the film.

The corrugated structure formed from the self-corrugating laminate can serve as a light guide or can incorporate optical elements such as OLED, phosphorescent layers, fluorescent materials, liquid crystal layers, etc.

There are numerous structural and functional applications of such a structure and the above list is not meant to be limiting. Instead, the self-corrugating laminates and resulting corrugated structures are meant to be building blocks to enable a wide range of new structures and allow for an entirely new manufacturing method.

### EXAMPLES

The following experimental methods were used to characterize the films, self-corrugating laminates and corrugated structures.

Shrinkage was determined by immersing a 100 mm×100 mm sample of the shrink film sample in water at 95° C. Hot water was used because copolyester shrink films (Tg=72° C.) were used for the experiments. Film was held in the bath for at least 30 seconds to ensure full shrinkage was complete. The length of the sample was then measured and the shrinkage in each direction determined by the following formula:

Percent shrinkage=(Lo−L)/Lo*100 (3)

in which L is the length after shrinkage and Lo is the initial length (100 mm). For shrink films having a Tg >100° C., hot water can no longer be used, so either hot oil or hot air is required. For these tests, the temperature of shrinkage should be at least Tg+20° C. and the sample held until full shrinkage is acquired. This is typically about 30 seconds for liquid media and 1 minute for hot air ovens.

Shrink stress was measured in a similar manner. A strip of film 1 inch (25.4 mm) wide was mounted in a tensile tester apparatus such that slack is removed. The film is then rapidly heated to above Tg and the maximum force recorded. The shrink stress is the maximum force divided by the initial cross-sectional area of the film strip.

The modulus for the non-shrinkable core was taken from the literature for each material and/or measured by traditional tensile testing methods (ASTM D882).

Corrugation quality was determined by visual examination with ratings on a scale from 1 to 5. The following criteria were used:

Rating 5—excellent quality with uniformly defined corrugation

Rating 4—good quality with only a few minor defects

Rating 3—fair quality, unacceptable for many applications

Rating 2—poor quality (unacceptable)

Rating 1—very poor quality (or corrugation did not form)

### Examples 1-13

### Corrugated Structures with Polycarbonate Core

For these examples, a series of uniaxially stretched films were bonded to opposing sides of a polycarbonate film core using a UV adhesive (Dymax SC330 gel). The copolyester shrink layer comprised Eastman Embrace LV™ (Eastman Chemical Company, Kingsport, Tenn.), a material commonly used for shrink film packaging (Tg=72° C.). To make the shrink film, a cast film 0.25 mm thick was extruded to create the unoriented base material. This film was then stretched on a Bruckner laboratory film stretcher at a nominal temperature of 82° C. Stretch ratio was varied from 1.25× up to 2× which yielded films having shrinkage from about 20% up to 50% (see Table I). The exception was for samples 7-9, where the film was extruded and stretched on a larger scale tenter frame at Marshall and Williams (Providence, R.I.). Next these shrink films were cut into 1 inch (25.4 mm) wide strips and then bonded to 25.4 mm wide strips of polycarbonate (core) film using the UV curable adhesive. Small stripes of adhesive were painted onto one side of the core at fixed intervals (Po was either 19 mm, 25.4 mm or 38 mm depending on the example). The core was then affixed to one of the shrink layers and passed through a UV tunnel to cure the bond. This was then repeated on the reverse side of the core layer using the same bonding interval as before, but with the bonds staggered by Lo/2. This side was then cured with the UV lamp as before. The result was a laminate including upper and lower shrinkable film layers and a non-shrinkable core bonded between the upper and lower shrinkable film layers.

Upon completion of the laminate, the sample was then exposed to steam to induce corrugation. The steam was supplied by a modified paint stripper plumbed into a metal pot. The film sample was placed into the steam pot, and allowed to shrink/corrugate for about 15 to 30 seconds. The sample was then removed and visual assessment made.

Results of the assessment are shown in Table I. It was observed that good or excellent quality corrugation was achieved when the percent shrinkage was in the 20 to 45% range. In contrast, CE10 through CE12 showed very poor quality due to higher shrinkage, which caused excessive wrinkling and inconsistent aspect ratios of the pleats. CE10, in contrast, did not show any signs of buckling because the corrugation ratio was too high.

The aspect ratio (H/P) of the corrugated structure was found to be influenced by the shrinkage of the film for all samples tested. For low shrinkage (Examples 1-3), the aspect ratio ranged from 0.29 to 0.33. For the 33% shrinkage films (Ex 4-6) the aspect ratio ranged from 0.52 to 0.56. For the 42% shrinkage films (Ex 7-9) the aspect ratio ranged from 0.53 to 0.62 and for the 50% shrinkage samples (CE 10-13), the aspect ratio ranged from 0.76 to 0.9. The latter samples also exhibited much more variability in the aspect ratio from peak to peak given the more wrinkled structure.

### Examples 14-18

### Corrugated Structures with PCTG Copolyester

These examples followed the same procedure as with Example 1, except that the core layer was made from Eastman Tritan™ high Tg copolyester (nominal Tg=120° C.). Results of the assessment are shown in Table I.

### Examples 19-23

### Corrugated Structures with an Aluminum Foil Core

This example was the same as above except various thicknesses of aluminum foil were used as the core layer. Additionally, some of the shrink films having 30% shrinkage were produced on a commercial tenter frame at Marshall and Williams (Providence, R.I.). This allowed us to produce larger areas of film versus the laboratory film stretcher. Aluminum is much higher in modulus than polymeric cores, so thickness and/or Po spacing was modified accordingly. As observed with the data in Table I, the behavior follows the same general trends as with the polymeric cores.

### Examples 24-39

### Corrugated Structures with PCTG Copolyester

These examples are similar to Examples 14 through 18 except the tentered shrink film was used instead (samples 24-34). In Examples 34 through 39, biaxially stretched film was used in place of uniax film even though the films were bonded in a linear uniax-like pattern. There was some lateral shrinkage of the film due to the off-axis shrinkage, but the characteristics of the film that control corrugation were still the same as with the true uniaxial shrinking samples.

### Example 40-43

### Curved Structures

In this set of examples, the same procedure was followed as Example 1, except that shrink films of differing shrinkage were used on side 2 versus side 1 (a 20% shrinkage film was used for side 1 for all examples). The core for all of these samples was a 0.1 mm polycarbonate and the adhesive bond lines were made with UV curable adhesive as before. Bond spacing Lo was also varied. The films were observed to curve with the exact amount depending on Po and the shrinkage of the film. Radius of curvature R, for the inside surface was estimated by tracing the inside edge of the curved corrugated structure and using a compass to try to match the line via trial and error. These values are listed in Table II along with theoretically calculated values based on Equation (5). The curvature was well defined for all of the samples and followed well with theory. Note that Example 43 had such a small radius of curvature that it wrapped into a coil. This could be desirable or undesirable, depending on the end-use application.

### Example 44

### Larger Corrugated Structure with Stamp Printing Method

To simulate scale-up of the concept, a laminate with uniaxial structure was created using tentered copolyester shrink film (1.25×, 30% shrinkage, 0.16 mm thick) and a polycarbonate core layer (0.1 mm). The films are identical to those described in Example 4, except the polyester film was a tentered film sample and had slightly different shrinkage and thickness properties. A 225 mm by 120 mm wide sample of each film was cut with the shrinkage direction parallel the long axis. To simulate printing of an adhesive, a linoleum block was CNC machined to produce a stamp having 3 mm (nominal) bond lines and a separation Po=19 mm. UV-curable adhesive was wiped onto this linoleum stamp pad using a breyer roll and the adhesive then transferred to the core layer by pressing the stamp against the film. This was repeated for the reverse side with the bond line staggered by Po/2. Shrinkage and corrugation of the laminate was induced using a hot air gun. The resulting structure had excellent corrugation definition with a final height H of approximately 6 mm and final P spacing of approximately 14 mm (H/P=0.42).

### Example 45

### Hermetically Sealed Corrugation

In this example, the shrink layers were made from 30% shrinkage, 0.16 mm thick, uniaxially stretched copolyester and the core was a 0.1 mm polycarbonate similar to Example 44. The PC core was cut to a nominal 125 mm wide by 200 mm long. The shrink layers were also cut 200 mm long but were wider (150 mm). Bonding was performed as above using Po=19 mm using the UV curable adhesive. In addition to this bonding, however, the outer edges of the shrinkable film layers of the laminate were heat sealed using an impulse bar sealer to form an air-tight laminate. More specifically, on the edges of the laminate a shrink-to-shrink layer bond was formed since the core layer width was reduced. Once sealed, the sample was corrugated using hot steam resulting in an excellent quality corrugated structure with air trapped inside. Furthermore, the structure had more rigidity because of the compression of the air trapped inside.

### Example 46

### Corrugation by Two-Layer Process (A/B/B/A)

In this example, a single layer of 30% shrinkage, 0.16 mm thick, uniaxially stretched copolyester was bonded to opposing sides of a 0.1 mm polycarbonate core with a spacing Po=25.4 mm. These films are identical to Example 5 except the polyester shrink film was a tentered film sample and had slightly different thickness and shrinkage. Bonding was performed by heat sealing via an impulse bar sealer. Width was nominally 200 mm. This film was then cut in half to produce two, 100 mm wide “pre-lams” having an “A/B” configuration.

Next, these two pre-lams were bonded together in an A/B/C/B/A structure where A is the shrink layer, B is the core layer and C is an adhesive. This was accomplished by placing the films together (core against core) and bonding in place using 3M VHB™ adhesive tape. Note that the bond lines were staggered by Po/2 to ensure proper corrugation. This structure was then placed in steam to create an excellent quality corrugated structure. The “core” in this case was a composite consisting of 2 layers of 0.1 mm PC film, and the adhesive layer. Such a structure was significantly easier to produce than the traditional 3 layer examples above and was more conducive to a wider range of bonding methods since only 2 layers need be joined at a time.

### Example 47

### Corrugation by Three-Layer Process (A/B/C/B/A)

The outer shrinkable layers of this structure were produced from Eastman Embrace LV™ copolyester (Eastman Chemical Company, Kingsport, Tenn.), a material commonly used for shrink film packaging (Tg=72° C.). To make the shrinkable film, a cast film 0.18 mm thick was extruded to create the unoriented base material. This film was then stretched on a tenter frame 1.5× at a nominal temperature of 82° C. resulting in a nominal ultimate shrinkage of 33%. The final film thickness was 0.12 mm.

In the next step, the shrink film was RF sealed to a non-shrinkable layer of Eastman Tritan™ copolyester (nominal Tg=105° C.) with a Cosmos-Kabar RF welder (10 kW, 27 MHz). The non-shrinkable layer was nominally 0.1 mm thick. The RF seal welds consisted of bond lines that were 3 mm wide across the width of the sample, and were spaced Po=20 mm apart. This produced a two-layer pre-lam structure consisting of a shrinkable and a non-shrinkable layer with a total size of about 100 mm by 300 mm. Weld lines were perpendicular to the long direction.

To create a laminate, a stack consisting of two pre-lams and a non-shrinkable functionalized layer C was assembled in A/B/C/B/A configuration where A is a shrinkable layer, B is a non-shrinkable layer and C is the non-shrinkable functionalized layer which in this example includes a thermoelectrically active circuit printed thereon.

Layers A and B were bonded by RF sealing as already described. Layers B and C are bonded using 3M VHB™ double sided tape (nominally 1 mil thick) as described in Example 46. Care was taken to ensure that the bond lines for the top and bottom layers were staggered by Po/2 to ensure proper corrugation. While it is also possible to bond the A layer directly to C, we have found that the deposited thermoelectric elements are not as receptive to direct RF sealing. Furthermore, having an intermediate protective layer in between to help spread the load and works better than directly adhering strips of adhesive only over the junctions.

Once laminated, the structure was heated with a hot air gun (Master Heat Gun™ Model HG-501A on high setting rated at 399C). The air gun was held about 10 to 20 cm from the film and swept back and forth to activate shrinkage and induce corrugation. The resulting module was of excellent quality having a total thickness of 4.7 mm and a final P=16 mm. The final module was nominally 40 mm wide and 155 mm long.

### Example 48

### Glass Fiber Reinforced Corrugation

This example is similar to Example 47 except the non-shrinkable layer C was a glass fiber reinforced thermoplastic tape. The tape contained 60% continuous glass fiber by volume with the glass aligned in the machine direction. The tape was nominally 0.25 mm thick and the thermoplastic carrier was PETG. The shrink layers A consisted of 0.6 mm nominal shrinkable film having a shrinkage of 42% whereas the non-shrinkable layers B were Tritan™ copolyester nominally 0.1 mm thick. Bonding of the A and B layers was performed by RF sealing as described in Example 47, except Po was increased to 32 mm due to the greater stiffness of the glass core. The glass reinforced core was bonded between the B layers using double sided 3M VHB™ tape.

Once laminated, the structure was heated with a hot air gun (Master Heat Gun™ Model HG-501A on high setting rated at 399C). The air gun was held about 10 to 20 cm from the film and swept back and forth to activate shrinkage and induce corrugation. The resulting module was of good quality having a total thickness of 7 mm and a final P=26 mm. The resulting structure had a lower aspect ratio of 0.27 because the more rigid glass core resisted buckling.

### Example 49

### Corrugation with Crosslinked Rubber

In this example, two pieces of pre-stretched crosslinked styrene-butadiene rubber (SBR) nominally 1 mm thick and 100 mm wide, were bonded with a non-shrink Tritan™ copolyester layer nominally 0.1 mm thick and of similar width. To accomplish this, first, a piece of SBR was stretched nominally 1.25× and then clamped to a wooden board in its stretched state using c-clamps. To this was then bonded the nonshrink layer using double-sided fletching tape (Bohning™ feather fletching tape) spaced at Po=25.4 mm. Additional staggered fletching tape strips were then placed on the top side of the nonshrink core and a 2^{nd} layer of SBR stretched across and pushed down onto the awaiting strips of tape where it too was clamped in place. With bonding achieved, the clamps were then released allowing the SBR to retract. This retraction caused aesthetically pleasing corrugations in the structure even though no heat was applied. These corrugations were also reversible and could be removed and then recreated simply by re-stretching and then releasing the rubber layers.

### Example 50-52

### Sound Damping Structures

These examples was identical to Example 46 except that they were modified to provide enhanced sound/vibration damping. In example 50, the air space created by the corrugations was filled with cotton balls. In example 51, this air space was filled with injectable foam (Dow Chemical Great Stuff™ insulating sealing foam). In example 52, a structure similar to Example 47 was produced except the core layer C was a piece of the rubber insulating foam used to line shelves and drawers (Duck Brand Easy™ shelf liner). In all three, the corrugated structures had a noticeably damped/deadened sound when tapped against a hard surface.

### Examples 53-55

### Corrugated Structures from Laminates with Biaxial Shrinkage Film and Formation of a 3-D Structures

In Example 53, two layers of biaxially oriented copolyester shrinkable film were bonded to opposing sides of a 0.1 mm PC core layer. The shrink film was stretched 1.25×1.25 (25% shrinkage in each direction) using the Bruckner laboratory film stretcher. Each film layer was cut into a circle with a nominal diameter of 150 mm.

Prior to bonding, eight lobes or flutes were formed in the core similar to FIG. 6. If this material was not removed, the core layer would likely collapse in on itself during shrinkage and impede uniform corrugation. The layers were then bonded together using UV curable adhesive in a concentric ring pattern. Spacing (Po) between these rings was 19 mm and the top and bottom set of bond lines were staggered by Po/2. The laminate was then corrugated by heating with a hot air gun. Corrugation caused the material to buckle in a radially symmetric pattern as the overall radius of the films decreased. The resulting film was substantially flat on its outer surfaces but corrugated in a ring-like structure.

Example 54 was identical to 53 except that the film was also shaped in conjunction with corrugation using a dome shaped mold. The mold—consisting of a matched plug and bowl section—was mounted on a benchtop dental thermoformer (used to make impressions for dental offices). Prior to forming, the mold was preheated to approximately 110° C. The film structure was then placed on the bowl mold while allowing the plug to apply light pressure. As the shrinkable film began to shrink and the laminate corrugate, the plug pressure was increased to help push the part down into the mold. If pressure was applied too quickly, corrugation would not sufficiently develop (or the corrugation would collapse). Vacuum assist was also used to help pull the structure into the bowl cavity and reduce the overall stress on the newly formed corrugations. The net result was a nicely curved bowl shape structure having concentric corrugation.

Example 55 was identical to 53 except that the top layer of shrink film was replaced with a film stretched 1.5×1.5 and having 33% nominal shrinkage in each direction. Upon heating, the shrinkage differential caused the corrugation to naturally curve into a bowl shape. Although mold tooling was not strictly required, it was still used to help guide the structure and produce a more uniform and well-defined surface.

### Example 56

In this example, a single layer of 30% shrinkage, 0.16 mm thick, uniaxially stretched copolyester was bonded to one side of a 0.1 mm non-shrinkable polycarbonate core along bond lines with a spacing Po=25.4 mm. These films are identical to Example 5 except the polyester shrink film was a tentered film sample and had slightly different thickness and shrinkage. Bonding was performed by heat sealing via an impulse bar sealer. Width was nominally 200 mm. This film was then cut in half to produce two, 100 mm wide “pre-lams” having an “A/B” configuration.

Next, these two pre-lams were bonded together in an A/B/B/A structure using an adhesive to bond the adjacent non-shrinkable films. This was accomplished by placing the films together (with non-shrinkable films adjacent) and bonding in place using 3M VHB™ adhesive tape. Note that the bond lines were staggered by Po/2 to ensure proper corrugation. This structure was then placed in steam to create an excellent quality corrugated structure. The non-shrinkable core in this example includes 2 layers of 0.1 mm non-shrinkable film and the adhesive. Such a structure was significantly easier to produce than the traditional 3 layer examples above and was more conducive to a wider range of bonding methods since only 2 layers need be joined at a time.

TABLE I

| | | | | Shrink | | | | | |
|---|---|---|---|---|---|---|---|---|---|
| | | Po | Shrinkage | Stress | Core E | h (core) | h (shrink) | corrugation | |
| Ex. # | core | (mm) | (%) | (MPa) | (MPa) | (mm) | (mm) | ratio | Rating |
| 1 | PC | 19 | 20 | 0.4 | 2000 | 0.10 | 0.16 | 0.281 | 5 |
| 2 | PC | 25.4 | 20 | 0.4 | 2000 | 0.10 | 0.16 | 0.157 | 5 |
| 3 | PC | 38 | 20 | 0.4 | 2000 | 0.10 | 0.16 | 0.070 | 4 |
| 4 | PC | 19 | 33 | 1.3 | 2000 | 0.10 | 0.15 | 0.092 | 2 |
| 5 | PC | 25.4 | 33 | 1.3 | 2000 | 0.10 | 0.15 | 0.051 | 4 |
| 6 | PC | 38 | 33 | 1.3 | 2000 | 0.10 | 0.15 | 0.023 | 3 |
| 7 | PC | 19 | 42 | 1.8 | 2000 | 0.10 | 0.23 | 0.044 | 3 |
| 8 | PC | 25.4 | 42 | 1.8 | 2000 | 0.10 | 0.23 | 0.025 | 3 |
| 9 | PC | 38 | 42 | 1.8 | 2000 | 0.10 | 0.23 | 0.011 | 2 |
| CE10 | PC | 19 | 50 | 3.1 | 2000 | 0.10 | 0.10 | 0.058 | 1 |
| CE11 | PC | 25.4 | 50 | 3.1 | 2000 | 0.10 | 0.10 | 0.032 | 1 |
| CE12 | PC | 38 | 50 | 3.1 | 2000 | 0.10 | 0.10 | 0.014 | 2 |
| CE13 | PC | 19 | 25 | 0.4 | 2000 | 0.15 | 0.16 | 0.948 | 1 |
| 14 | PCTG | 25.4 | 25 | 0.4 | 1520 | 0.15 | 0.16 | 0.403 | 4 |
| 15 | PCTG | 38 | 25 | 0.4 | 1520 | 0.15 | 0.16 | 0.180 | 4 |
| 16 | PCTG | 19 | 33 | 1.3 | 1520 | 0.15 | 0.15 | 0.235 | 3 |
| 17 | PCTG | 25.4 | 33 | 1.3 | 1520 | 0.15 | 0.15 | 0.131 | 4 |
| 18 | PCTG | 38 | 33 | 1.3 | 1520 | 0.15 | 0.15 | 0.059 | 3 |
| CE19 | AL | 50.8 | 30 | 0.72 | 70000 | 0.01 | 0.36 | 0.0004 | 1 |
| 20 | AL | 50.8 | 30 | 0.72 | 70000 | 0.10 | 0.36 | 0.313 | 5 |
| CE21 | AL | 50.8 | 30 | 0.72 | 70000 | 0.02 | 0.36 | 0.003 | 1 |
| CE22 | AL | 25.4 | 75 | 7 | 70000 | 0.02 | 0.36 | 0.001 | 2 |
| 23 | AL | 50.8 | 30 | 0.72 | 70000 | 0.10 | 0.36 | 0.313 | 5 |
| CE24 | PCTG | 25.4 | 30 | 0.72 | 1520 | 0.10 | 0.36 | 0.032 | 3 |
| 25 | PCTG | 25.4 | 30 | 0.72 | 1520 | 0.18 | 0.36 | 0.170 | 4 |
| 26 | PCTG | 25.4 | 30 | 0.72 | 1520 | 0.27 | 0.36 | 0.574 | 5 |
| 27 | PCTG | 19.05 | 30 | 0.72 | 1520 | 0.10 | 0.36 | 0.056 | 3 |
| 28 | PCTG | 19.05 | 30 | 0.72 | 1520 | 0.18 | 0.36 | 0.302 | 4 |
| 29 | PCTG | 19.05 | 30 | 0.72 | 1520 | 0.27 | 0.36 | 1.020 | 5 |
| 30 | PCTG | 12.7 | 30 | 0.72 | 1520 | 0.10 | 0.36 | 0.127 | 4 |
| 31 | PCTG | 12.7 | 30 | 0.72 | 1520 | 0.18 | 0.36 | 0.680 | 5 |
| CE32 | PCTG | 12.7 | 30 | 0.72 | 1520 | 0.27 | 0.36 | 2.295 | 1 |
| CE33 | PCTG | 25.4 | 30 | 0.72 | 1520 | 0.51 | 0.36 | 3.965 | 1 |
| CE34 | PCTG | 19.05 | 30 | 0.72 | 1520 | 0.51 | 0.36 | 7.048 | 1 |
| CE35 | PCTG | 12.7 | 30 | 0.72 | 1520 | 0.51 | 0.36 | 15.859 | 1 |
| 36 | PCTG | 12.7 | 25 biax | 0.6 | 1520 | 0.10 | 0.20 | 0.266 | 4 |
| 37 | PCTG | 12.7 | 33 biax | 2.5 | 1520 | 0.20 | 0.13 | 0.818 | 4 |
| CE38 | PCTG | 12.7 | 50 biax | 3.2 | 1520 | 0.20 | 0.11 | 0.710 | 3 |
| CE39 | PCTG | 12.7 | 66 biax | 4.9 | 1520 | 0.20 | 0.10 | 0.522 | 3 |

TABLE II
Data for Curved Samples

| | | | | | Radius of | |
|---|---|---|---|---|---|---|
| | Shrinkage | Shrinkage | Po | H | Curvature, R | R (calc) |
| Ex. # | Layer 1 | Layer 2 | (mm) | (mm) | (mm) | (mm) |
| 50 | 20 | 33 | 25.4 | 7 | 44 | 36 |
| 51 | 20 | 33 | 19 | 4.3 | 25 | 22 |
| 52 | 20 | 50 | 19 | 5.5 | 6.5 | 9 |

That which is claimed is:

1. A self-corrugating laminate, said laminate comprising an upper and a lower shrinkable film layer each having at least one axis of shrinkage and a non-shrinkable core having a top surface and a bottom surface and bonded between said upper and lower shrinkable film layers along bond lines, wherein the bond lines that bond said upper shrinkable film layer to said top surface of said non-shrinkable core are staggered relative to the bond lines that bond said lower shrinkable film layer to said bottom surface of said non-shrinkable core such that upon shrinkage of said shrinkable film layers, a corrugated structure comprising structural corrugations in said non-shrinkable core is formed.
wherein at least a portion of the bond lines are arranged substantially perpendicular to the axis of shrinkage of their adjacent connected shrinkable film layer and
wherein each of said shrinkable film layers exhibit a percent shrinkage along an axis of shrinkage of from about 10 to about 45 percent.

2. The self-corrugating laminate of claim 1, wherein said shrinkable film layers each exhibit a percent shrinkage of from 15 to 35 percent.

3. The self-corrugating laminate of claim 1, wherein said shrinkable film layers each exhibit a percent shrinkage of from 20 to 30 percent.

4. The self-corrugating laminate of claim 1, wherein the percent shrinkage of said upper shrinkable layer and the percent shrinkage of said lower shrinkable layer differ if at all by no more than 10%.

5. The self-corrugating laminate of claim 1, wherein the percent shrinkage of said upper shrinkable layer and the percent shrinkage of said lower shrinkable layer differ by at least 10%.

6. The self-corrugating laminate of claim 1, wherein said self-corrugating laminate exhibits a corrugation ratio from 0.02 to 0.9, upon shrinkage of the shrinkable film layers, according to the following formula:
$$0.02 < \frac{1}{3} * \frac{{π}^{2} {E}_{c} {h}_{c}^{3}}{{P}_{o}^{2} σ {h}_{s}} < 0.9$$
wherein hc is thickness of said non-shrinkable core Ec is the modulus of said non-shrinkable core, Po is the spacing between bond lines, σ is the shrink stress of said shrinkable film layers, and hs is the thickness of each of said shrinkable film layers, each expressed in units selected such that said corrugation ratio is dimensionless.

7. The self-corrugating laminate of claim 6, wherein said laminate exhibits a corrugation ratio from 0.05 to 0.8.

8. The self-corrugating laminate of claim 6, wherein said laminate exhibits a corrugation ratio from 0.1 to 0.75.

9. A corrugated structure formed from the self-corrugating laminate of claim 1, said structure comprising a non-shrinkable core with structural corrugations formed therein.

10. The corrugated structure of claim 9, characterized by an aspect ratio of from about 0.1 to about 0.8 according to the following formula:
0.1<Hc/P<0.8
wherein Hc is the height of the structural corrugations and P is the bond line spacing after shrinkage and the units for Hc and P are the same.

11. The corrugated structure of claim 10, wherein said aspect ratio is from 0.2 to 0.6.

12. The self-corrugating laminate of claim 1, wherein the upper and lower shrinkable film layers are comprised of one or more of a polyester, a copolyester, an acrylic, polyvinyl chloride, polylactic acid, a polycarbonate, a styrenic polymer, a polyolefin, a polyamide, a polyimide, a polyketone, a fluoropolymer, a polyacetal, a cellulose ester and a polysulfone.

13. The self-corrugating laminate of claim 1, wherein the upper and lower shrinkable film layers are comprised of one or more of a polyester, a copolyester, a polycarbonate, an acrylic, or a styrenic polymer.

14. The self-corrugating laminate of claim 1, wherein said bond lines comprise an adhesive.

15. The self-corrugating laminate of claim 1, wherein said bond lines comprise a heat-weld.

16. The self-corrugating laminate of claim 1, wherein said bond lines comprise a solvent-weld.

17. The self-corrugating laminate of claim 1, wherein at least one of said non-shrinkable film layers is provided with one or more flutes.

18. The corrugated structure of claim 9, wherein the height of said corrugations Hc varies within said structure.

19. The self-corrugating laminate of claim 1, wherein the non-shrinkable film layer is formed from multiple layers of non-shrinkable film.
